(19) United States
(12) Patent Application Publication
(10) Pub. No.: US 2021/0097955 A1
(43) Pub. Date: Apr. 1, 2021

(54) AUTOMATICALLY CALIBRATING DISPLAY COLOR OUTPUT ON LID CLOSURE

(71) Applicant: LENOVO (Singapore) PTE. LTD., New Tech Park (SG)

(72) Inventors: John Weldon Nicholson, Cary, NC (US); Howard Locker, Cary, NC (US); Daryl C. Cromer, Raleigh, NC (US)

(21) Appl. No.: 16/589,626

(22) Filed: Oct. 1, 2019

(51) Int. Cl. G09G 5/04; G06F 3/14; G01J 3/50

(52) U.S. Cl. CPC G09G 5/04; G06F 3/1423; G09G 2360/145; G09G 2320/0666; G09G 2320/0693; G01J 3/506

(57) ABSTRACT

Apparatuses, methods, systems, and program products are disclosed for automatically calibrating display color output on lid closure. An apparatus includes a processor and a memory that stores code executable by the processor. The code is executable to detect a lid closure event for a lid that closes to obscure a display of a portable electronic device. In response to detecting the lid closure event, the processor performs a color calibration of the display, including using a color sensor to measure a color output by the display with the lid in a closed position and updating color calibration parameters for optimizing the color output. A method, system, and computer program product may perform the functions of the apparatus.

### FIELD

The subject matter disclosed herein relates to calibrating display color and more particularly relates to automatically calibrating display color output on lid closure.

### BACKGROUND

As the resolution and quality of displays for portable electronic devices such as laptops, graphics workstations, and tablets, manual color calibration may be performed to ensure that display colors, brightness, contrast, and other display attributes are displayed consistently over time.

### BRIEF SUMMARY

Apparatuses, methods, systems, and program products are disclosed for automatically calibrating display color output on lid closure. An apparatus, in one embodiment, includes a processor, and a memory that stores code executable by the processor. The code is executable, in certain embodiments, to detect a lid closure event for a lid that closes to obscure a display of a portable electronic device, and in response to detecting the lid closure event, to perform a color calibration of the display that includes using a color sensor to measure a color output by the display with the lid in a closed position and updating color calibration parameters for optimizing the color output.

A method for automatically calibrating display color output on lid closure includes detecting, by use of a processor, a lid closure event for a lid that, in a closed position, obscures a display of a portable electronic device, and in response to detecting the lid closure event, performing, by use of a processor, a color calibration of the display which includes, in various embodiments, using a color sensor to measure a color output by the display with the lid in the closed position and updating color calibration parameters for optimizing the color output.

A program product for automatically calibrating display color output on lid closure includes, in one embodiment, code that is executable by a processor to detect a lid closure event for a lid that, in a closed position, obscures a display of a portable electronic device, and in response to detecting the lid closure event, to perform a color calibration of the display which includes, in various embodiments, using a color sensor to measure a color output by the display with the lid in the closed position and updating color calibration parameters for optimizing the color output.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not, therefore, to be considered to be limiting of scope, the embodiments will be described and explained with additional specificity and detail through the use of the accompanying drawings, in which:

FIG. 1 is a schematic block diagram illustrating one embodiment of a system for automatically calibrating display color output on lid closure;

FIG. 2 is a schematic block diagram illustrating one embodiment of a display calibration apparatus for a portable electronic device;

FIGS. 3A-3C are perspective drawings illustrating one embodiment of an apparatus for automatically calibrating display color output on lid closure;

FIG. 4A-4B are perspective drawings illustrating another embodiment of an apparatus for automatically calibrating display color output on lid closure;

FIG. 5 is a schematic flow chart diagram illustrating one embodiment of a method for automatically calibrating display color output on lid closure;

FIG. 6 is a schematic flow chart diagram illustrating another embodiment of a method for automatically calibrating display color output on lid closure; and

FIG. 7 is a schematic flow chart diagram illustrating a further embodiment of a method for automatically calibrating display color output on lid closure.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine-readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field-programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object-oriented programming language such as Python, Ruby, R, Java, JavaScript, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which executes on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in one embodiment, includes a processor and a memory that stores code executable by the processor. The code is executable in certain embodiments, to detect a lid closure event for a lid that closes to obscure a display of a portable electronic device, and in response to detecting the lid closure event, perform a color calibration of the display which includes using a color sensor to measure a color output by the display with the lid in a closed position and updating color calibration parameters for optimizing the color output.

In one embodiment, the code is further executable by the processor to further perform a lid closure action selected from a sleep action, a shutdown action, a hibernate action, a restart action, a do-nothing action, and a custom action. In certain embodiments, the code is further executable by the processor to perform the lid closure action in response to completing the color calibration. In one embodiment, in response to the lid closure action being do-nothing, the code is further executable by the processor to continue to display content on a second display for the portable electronic device that is not obscured by the lid in the closed position while performing the color calibration on the display that is obscured by the lid in the closed position.

In one embodiment, the color calibration comprises multiple partial color calibrations corresponding to multiple lid closure events. In some embodiments, the code is further executable by the processor to determine, as a pre-condition to performing the color calibration, whether a predetermined time interval from completion of a prior color calibration has lapsed. In various embodiments, the code is further executable by the processor to measure a change in the calibration parameters from a preceding color calibration and to adjust the predetermined time interval inversely to the measured change. In some embodiments, the code is further executable by the processor to perform the color calibration using a Unified Extensible Firmware Interface (UEFI) application that performs the color calibration at the predetermined time interval, where the UEFI application wakes the portable electronic device in response to the predetermined time interval lapsing when the portable electronic device is in a state selected from a sleep state, a shutdown state, and a hibernate state.

In one embodiment, the code is further executable by the processor to determine, as a pre-condition to performing the color calibration, whether a predetermined time interval from detecting the lid closure event has lapsed. In certain embodiments, the code is further executable by the processor to determine as a further pre-condition to performing the color calibration whether a movement of the portable electronic device is below a predetermined threshold as a pre-condition to performing the color calibration. In one embodiment, the color sensor is integrated within a surface comprising a user input interface of the portable electronic device that opposes the display with the lid in the closed position. In another embodiment, the color sensor is integrated within the lid of the portable electronic device that opposes the display with the lid in the closed position.

A method for automatically calibrating display color output on lid closure includes, in one embodiment, detecting, by use of a processor, a lid closure event for a lid that, in a closed position, obscures a display of a portable electronic device, and in response to detecting the lid closure event, performing, by use of a processor, a color calibration of the display, including using a color sensor to measure a color output by the display with the lid in the closed position and updating color calibration parameters for optimizing the color output.

The method includes, in some embodiments, performing, by use of a processor, a lid closure action selected from a sleep action, a shutdown action, a hibernate action, a restart action, a do-nothing action, and a custom action. In certain embodiments, the method includes performing the lid closure action is in response to completing the color calibration. In various embodiments, in response to the lid closure action being do-nothing, the method includes continuing to display content on a second display for the portable electronic device that is not obscured by the lid in the closed position while performing the color calibration on the display that is obscured by the lid in the closed position.

In one embodiment, the color calibration includes multiple partial color calibrations corresponding to multiple lid closure actions. In one embodiment, the method includes determining, as a pre-condition to performing the color calibration, whether a predetermined time interval from completion of a prior color calibration has lapsed. In some embodiments, the method includes performing the color calibration using a Unified Extensible Firmware Interface (UEFI) at the predetermined time interval, wherein the UEFI application wakes the portable electronic device in response to the predetermined time interval lapsing when the portable electronic device is in a state selected from a sleep state, a shutdown state, and a hibernate state.

A program product for automatically calibrating display color output on lid closure includes, in one embodiment, code that is executable by a processor to detect a lid closure event for a lid that, in a closed position, obscures a display of a portable electronic device, and in response to detecting the lid closure event, to perform a color calibration of the display which includes, in various embodiments, using a color sensor to measure a color output by the display with the lid in the closed position and updating color calibration parameters for optimizing the color output.

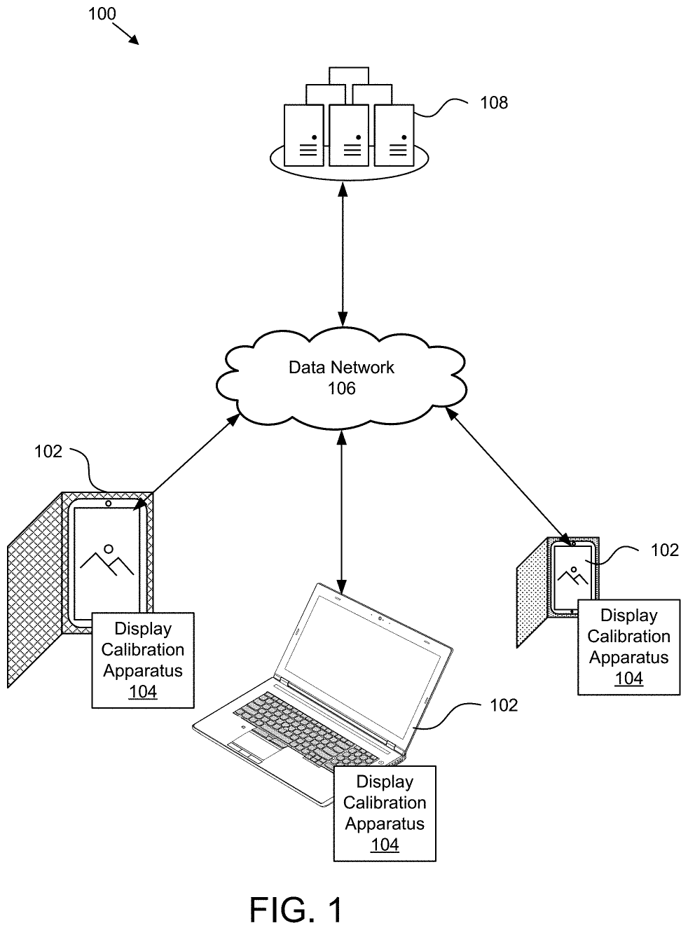

FIG. 1 is a schematic block diagram illustrating one embodiment of a system 100 for automatically calibrating display color output on lid closure. The system 100 may adjust display color calibration parameters based on color sensor measurements made automatically in response to detecting a lid closure event. In the depicted embodiment, the system 100 includes a display calibration apparatus 104 for use on one or more portable electronic device(s) 102 such as for example laptops, tablets, smartphones, and so forth.

In various embodiments, the system 100 includes a portable electronic device 102 that includes a processor, and a memory that stores code executable by the processor. The processor detects a lid closure event for a lid that closes to obscure a display of a portable electronic device and in response to detecting the lid closure event, the processor may automatically perform a color calibration of the display that includes using a color sensor to measure a color output by the display with the lid in a closed position, applying a color calibration algorithm to the color output, and updating color calibration parameters for optimizing the color output.

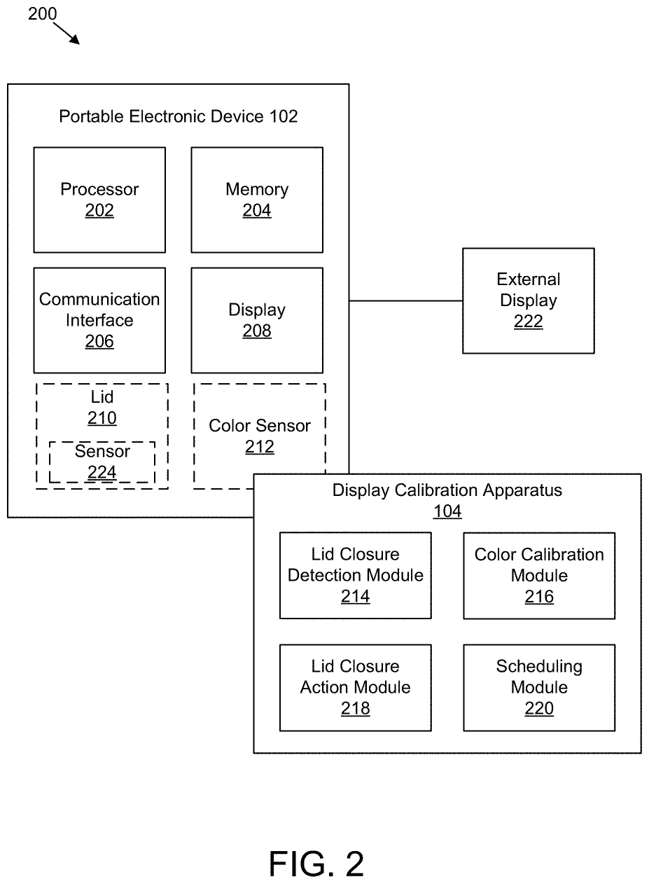

In certain embodiments, the system 100 includes a display calibration apparatus 104 for use on the portable electronic devices 102. Various embodiments of the display calibration apparatus 104 are described in more detail below with respect to FIG. 2. The display calibration apparatus 104 may be used to improve color display technology for certain applications that were historically used on workstations or desktop PCs as such applications become increasingly used on laptops, tablets, smartphones, as well as other portable electronic devices including a processor (e.g., a central processing unit (“CPU”), a processor core, a field-programmable gate array (“FPGA”) or other programmable logic, an application-specific integrated circuit (“ASIC”), a controller, a microcontroller, and/or another semiconductor integrated circuit device), a volatile memory, and/or a non-volatile storage medium, a display, a connection to a display, and/or the like.

For example, accurate display and use of colors may be important for certain applications such as digital photography, printing, image interpretation, graphic design, and so forth. Different displays for portable electronic devices may display the same digital image with slightly different colors due to differences in default settings and/or other variations between displays. Additionally, color performance (e.g., color temperature or brightness, gamma, and so forth) of color displays may vary based with, such as for example, such as backlighting for liquid crystal displays or organic light-emitting diodes (OLED)s may vary or drift over time.

Some electronic devices may allow color calibration to be performed manually based on a user's subjective color perception. A user may also manually run a color calibration program that measures a color output of a display to enhance consistency. However, some calibration programs may be time-consuming, and some users may neglect to perform color calibration with sufficient regularity to optimize the color output of the display.

In certain embodiments, the portable electronic devices 102 are communicatively coupled to one or more other portable electronic devices 102 and/or to one or more servers 108 over a data network 106, described below. The portable electronic devices 102, in a further embodiment, may include processors, processor cores, and/or the like that are configured to execute various programs, program code, applications, instructions, functions, and/or the like. For example, in some embodiments, the portable electronic devices 102 use the data network 106 to download application-specific calibration algorithms or to update color calibration data such as calibration parameters and/or profiles for later use.

The data network 106, in one embodiment, includes a digital communication network that transmits digital communications. The data network 106 may include a wireless network, such as a wireless cellular network, a local wireless network, such as a Wi-Fi network, an ad hoc network, and/or the like. The data network 106 may include a wide area network (“WAN”), a storage area network (“SAN”), a local area network (“LAN”), an optical fiber network, the internet, or other digital communications network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

In various embodiments, the system 100 may enable network display calibration by selecting a particular display as the “standard,” and saving the calibration values for use as a standard for the other displays which helps provide more consistent color matching across multiple portable electronic devices 102.

The wireless connection may be a mobile telephone network. The wireless connection may also employ a Wi-Fi network based on any one of the Institute of Electrical and Electronics Engineers (“IEEE”) 802.11 standards. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more portable electronic devices 102. The servers 108 may comprise back-end servers for facilitating machine translation of text/speech, analysis of machine-translated text using artificial intelligence, marking-up a copy of the machine-translated text, and/or the like.

FIG. 2 is a schematic block diagram illustrating one embodiment of an apparatus 200 that includes portable electronic device 102 that includes an instance of a display calibration apparatus 104 for the portable electronic device 102. In one embodiment, the portable electronic device 102 includes a processor 202, a memory 204, communication hardware 206, and a display 208. The memory 204 may include a semiconductor storage device, a hard disk drive, an optical storage device, a micromechanical storage device, or combinations thereof. The memory 204 may store code. The processor 202 may execute the code. The communication hardware 206 may communicate with other devices. The display 208 may display color output.

In some embodiments, the portable electronic device 102 may include a lid 210 and/or a color sensor 212. In certain embodiments, the lid 210, and/or the color sensor 212 are mechanically and/or electronically coupled to the portable electronic device 102. As used herein, the term “lid” may refer to a laptop lid with an integrated display, a surface or module of a multi-display device such as a 2-in-1, a hybrid or a convertible laptop where the surface obscures a front-facing display or a back-facing display, or a surface that obscures a display of a tablet, smartphone or another portable electronic device.

For example, some laptops have a display integrated into a lid that is coupled (e.g., with hinges) to the laptop body so that the lid closes the display down over a user input surface such as a keyboard/touchpad area. In certain embodiments, the lid closure detection module may include software, firmware, hardware, or a combination thereof. In some embodiments the lid closure detection module 214 includes code that is executed by the processor 202 to read a sensor 224 such as a Hall effect switch, a mechanical switch, an optical switch, or similar device to detect that the lid is closed i.e., that the display 208 is obscured by the lid 210. For example, a user may close a lid of a laptop at the end of a work period the laptop in a backpack or briefcase while moving around.

In one embodiment, the display calibration apparatus 104 includes a lid closure detection module 214 that detects a lid closure event for the lid 210 that closes to obscure the display 208 of the portable electronic device 102 In certain embodiments, the lid closure action module 218 performs one or more predefined functions in response to the lid 210 being closed. Unlike some conventional lid closure software, in various embodiments of the lid closure action module 218, a lid closure action may be intercepted, rescheduled, delayed, and so forth by the display calibration apparatus 104 so that the processor 202 may execute code in a color calibration module 216 in response to the lid closure detection module 214 detecting a lid closure event before performing any lid closure action is saved, rescheduled, or intercepted, by the color calibration module 216.

Examples of a lid closure action may include a sleep action in which the portable electronic device 102 enters a low-power state, a shutdown action in which the portable electronic device 102 is shut down, a hibernate action in which a state of the portable electronic device 102 is saved to a nonvolatile memory such as a solid-state drive or hard disk, so that when the portable electronic device 102 is powered on again, the saved state is restored.

In certain embodiments, the lid closure action may include a restart action whereby the portable electronic device 102 is restarted when the lid closure action is performed e.g., after lid closure, the restart is delayed until after the color calibration is complete. In various embodiments, the lid closure action includes a do-nothing acting meaning that the portable electronic device 102 does nothing to affect the state of the portable electronic device 102 upon detecting a lid closure event other than the functions associated with the color calibration modules 216 and/or a scheduling module 220 that may be configured to schedule color calibration at predetermined intervals.

In some embodiments, the color calibration module 216 updates color calibration parameters for optimizing the color output of the display 208. The term “updates color calibration parameters,” as used herein, means determines and/or stores settings or parameters for the display 208 or for a device that provides inputs to the display 208 such as for example an integrated graphics chip or a graphics card so that the color output of the display 208 as measured by the color sensor 212 meets a predetermined color standard or color profile with color parameters such as luminance/brightness, contrast, color temperature, white point, black point, gamma, and so forth.

As used herein, in certain embodiments, the term “color calibration” may include adjusting display parameters and/or video/graphics source color output parameters so that the display meets a predetermined standard or profile. In some embodiments, the term color calibration also includes building a profile of the color output by the display 208 where the profile describes the display 208 so that a color-managed application displays or uses colors with enhanced accuracy and consistency on various devices.

For example, a graphics chip, graphics card, or color display may have default settings, parameters, lookup table values, and the list so that the term “updates color calibration parameters” refers to replacing the default color settings, parameters, lookup table values, etc., with color calibration parameters for producing a color output for the disp1ay 208 which meets the predetermined color standard or color profile. In various embodiments, the predetermined color standard or color profile may be configured for a particular application. For example, in certain embodiments, a different color profile may be used for viewing video content than for viewing stationary image content.

The color calibration module 216 may update the color calibration parameters to conform with any current or future color standards and/or profiles for displays 208 that may be known to those of skill in the art including those for use with the portable electronic devices 102. Examples of some color calibration parameters include luminance (which may also be referred to as brightness level), or color temperature (which may also be referred to as white point), black point, gamma, and so forth.

In various embodiments, the color calibration module 216 may update the color calibration parameters in a video output device, such as for example, a lookup table or LUT for a graphics or video card or chip. In certain embodiments, the color calibration module 216 may update the color calibration parameters in the display 208 of the portable electronic device 102. In other embodiments, the color calibration module 216 saves the color calibration parameters to a memory or file corresponding to the portable electronic device 102 or in a memory or file of a device in communication with the portable electronic device 102 over a network such as the data network 106.

In one embodiment, the display calibration apparatus 104 may include a color calibration module 216. In one embodiment, the color calibration module 216 includes code that when executed by a processor of the portable electronic device, performs a lid closure action selected from a sleep action, a shutdown action, a hibernate action, a restart action, a do-nothing action, and a custom action.

In various embodiments, the color calibration module 216 communicates with the color calibration module 216 and provides for the lid closure action to be intercepted or delayed according to predetermined settings so that the color calibration module 216 may perform the color calibration prior to the color calibration module 216 performing the lid closure action. Accordingly, the color calibration module 216 may include code that when executed by the processor of the portable electronic device performs the lid closure action in response to completing the color calibration.

In certain embodiments, in response to the lid closure action being do-nothing, the code is further executable by the processor 202 to continue to display content on a second display for the portable electronic device that is not obscured by the lid in the closed position while performing the color calibration on the display that is obscured by the lid in the closed position (e.g., an external display, or in the case of a 2-in-1 hybrid laptop, a second display that is not obscured when the lid 210 is in the closed position). With this capability, color calibration of an integrated display which is obscured or covered by the closed lid may occur while one or more second displays continues to display applications that are currently in use.

In certain embodiments, the color calibration module 216 performs only a partial calibration in response to a lid closure event so that the color calibration includes multiple partial color calibrations corresponding to multiple lid closure events. For example, in one embodiment, a partial color calibration corresponds to a calibration of one particular color channel such as a red, green, or blue color channel. In such an embodiment that includes three color channels, three lid closure events may each trigger a partial calibration for one of the three channels so that after three lid closures, all three color channels have been calibrated.

By performing partial calibrations, the display calibration apparatus 104 improves upon color calibration technology by enabling calibration to be performed on a regular basis where each execution of code in the color calibration module 216 takes less time to complete, thus saving battery life, charging faster, and minimizing the delay before the color calibration module 216 performs the lid closure action that was delayed to perform the color calibration .

In one embodiment, the display calibration apparatus 104 includes a scheduling module 220 that may be used to establish a predetermined schedule for the color calibration module 216 to perform color calibration of the display on a predetermined schedule. In one embodiment, the scheduling module 220 includes code that is executable by the processor 202 to determine, as a pre-condition to the color calibration module 216 performing the color calibration, whether a predetermined time interval from completion of a prior color calibration has lapsed.

In some embodiments, the color calibration module 216 includes code that is excludable by the processor 202 to measure a change in the calibration parameters from a preceding color calibration and the scheduling module 220 adjust the predetermined time interval inversely to the measured change. In other words, in various embodiments, in response to a larger measured change in the calibration parameters from a preceding color calibration, the scheduling module 220 schedules more frequent calibrations. Similarly, in response to a smaller measured change in the calibration parameters from preceding color calibration, the scheduling module 220 schedules less frequent calibrations.

In certain embodiments, the scheduling module 220 includes code that is executable by the processor 202 as a Unified Extensible Firmware Interface (UEFI) application or in some portable electronic devices as a basic input/output system (BIOS) application. In such embodiments, the UEFI application wakes the portable electronic device 102 in response to the predetermined time interval lapsing when the portable electronic device 102 is in a state such as for example a sleep state, shutdown state, and a hibernate state. This feature may be useful to permit the display calibration apparatus 104 to perform auto color calibration at a scheduled interval regardless of whether a user manually puts the portable electronic device 102 to sleep or in shut down mode before closing the lid 210.

In one embodiment, the scheduling module 220 includes code that is executable by the processor 202 determine as a precondition to performing the color calibration, whether a predetermined time interval from detecting the lid closure event has lapsed. This enables the display calibration apparatus 104 to delay color calibration for a predetermined period of time that may be set by a user profile, or other settings.

In various embodiments, the scheduling module 220 includes code that is executable by the processor 202 to determine as a further precondition to performing the color calibration whether a movement of the portable electronic device is below a predetermined threshold. In such an embodiment, the scheduling module 220 may include code to read a motion sensor such as an accelerometer included in the portable electronic device to detect motion. For example, it may be recommended to not perform color calibration of certain displays while the portable electronic device 102 is in motion since motion of the portable electronic device 102 may cause slight variations in color display parameters due to changes in electromagnetic fields, changes in ambient light, or other factors that are less than optimal for performing color calibration.

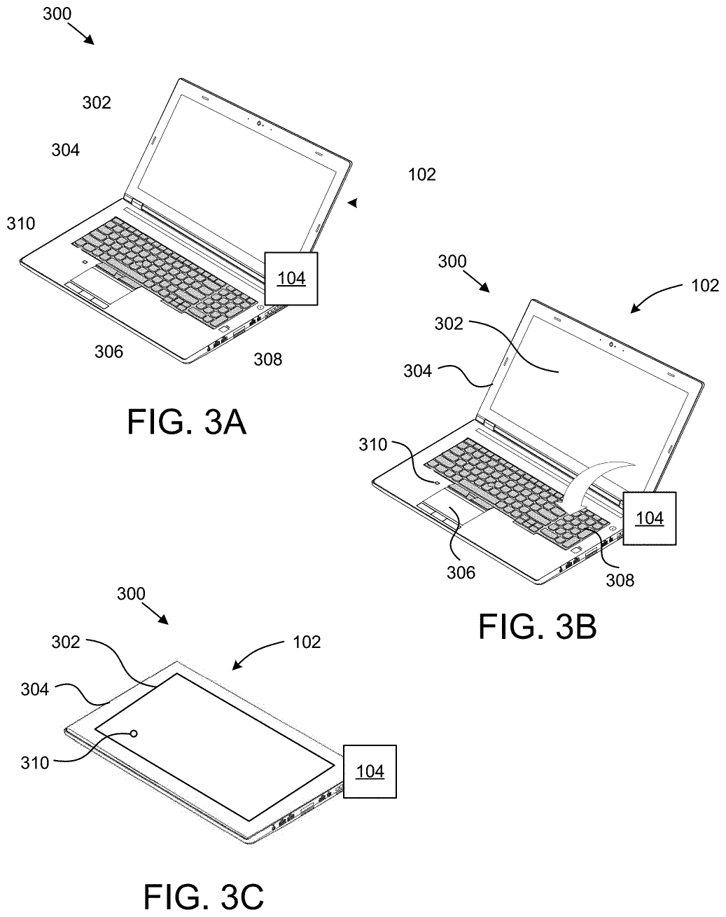

FIGS. 3A-3C are perspective drawings illustrating one embodiment of an apparatus 300 that includes a portable electronic device 102 (e.g., a laptop) with a display calibration apparatus 104 (as described above with respect to FIG. 2) for automatically calibrating display color output on lid closure. In the depicted embodiment, the portable electronic device 102 is depicted as a laptop having a display 302 integrated into a lid 304. The portable electronic device 102, e.g., a laptop, has a surface that includes one or more user input interfaces such as a keyboard 308 and or a touchpad 306. In the depicted embodiment, a color sensor 310 is integrated within a surface of the laptop that includes the user input interface meaning that the color sensor 310 would be disposed in the same general plane as the keyboard 308 and/or touchpad 306, for example in the palm rest or off to any side of the keyboard 308 and/or the touchpad.

In one embodiment of the apparatus 300, as depicted in FIG. 3B, a user may close the lid 304 so that the display 302 is obscured by closing the lid 304 against the surface that includes the keyboard 308, the touchpad 306, and the color sensor 310. Thus, the display calibration apparatus 104 of the portable electronic device 102 may detect a lid closure event for the lid 304 that obscures in a closed position the display 302 of the portable electronic device 102.

In response to detecting the lid closure event, i.e., with the lid in closed position as depicted in FIG. 3C, the display calibration apparatus 104 of the portable electronic device 102 may include code executable by the processor (e.g., 202 as depicted in FIG. 2) to read the color sensor 310 to measure a color outfit by the display 302 and to further update color calibration parameters for optimizing the color of the display 302.

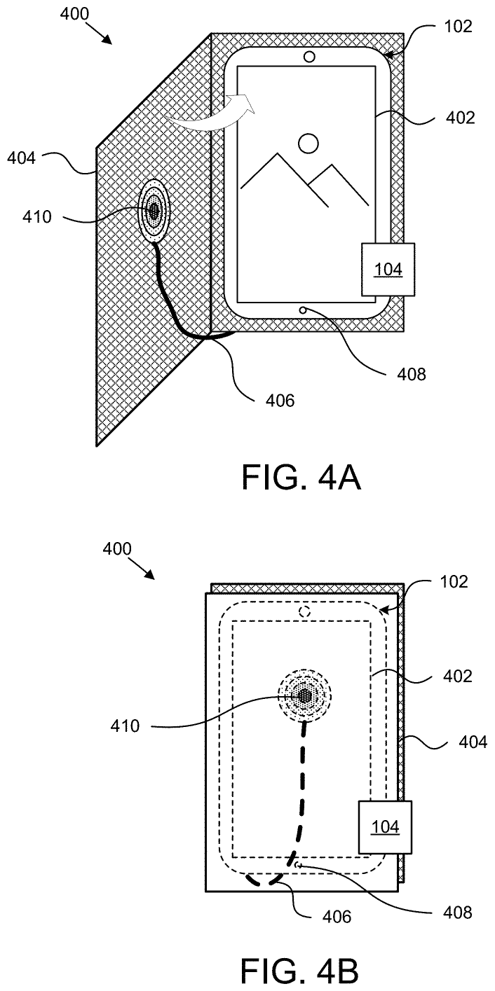

FIGS. 4A-4B are perspective drawings illustrating another embodiment of an apparatus 400 for automatically calibrating display color output on lid closure. The apparatus 400 includes a portable electronic device 102, e.g., a tablet, that has a display 402, a lid 404 (which may also be referred to as a cover or portfolio), and a display calibration apparatus 104. The display calibration apparatus 104 may be substantially as described above with respect to FIGS. 2 and 3. The portable electronic device 102 may also include a light sensor 408. In certain embodiments, the color sensor 410 is integrated within the lid 404 that opposes the display to with the lid in the closed position as shown in FIG. 4B.

In some embodiments, the color sensor 410 is communicatively coupled to the portable electronic device 102 through a connection interface 406 such as a USB interface, a Bluetooth interface, a near field communications interface, or any interface capable of transmitting signals from the color sensor 410 to the display calibration apparatus 104 of the portable electronic device 102. Accordingly, in such embodiments, the benefits of the display calibration apparatus 104 performing the automated color calibration of the display may be achieved for portable electronic devices that do not have an integrated color sensor.

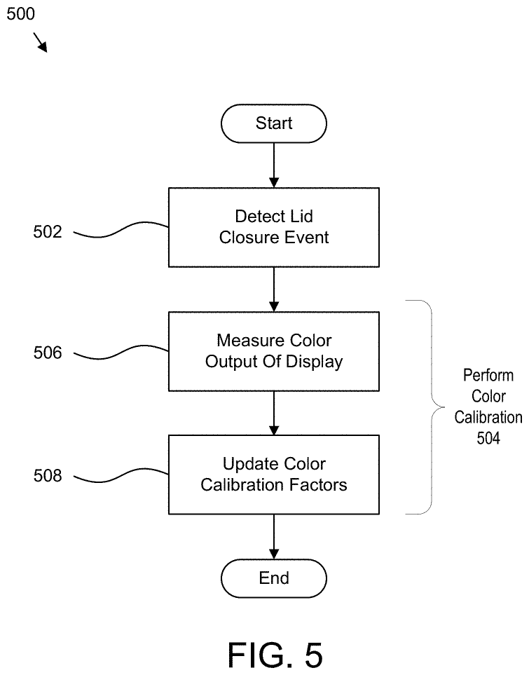

FIG. 5 is a schematic flow chart diagram illustrating one embodiment of a method 500 for automatically calibrating display color output on lid closure. In the embodiment, the method 500 begins and detects 502 by use of a processor, lid closure event for a lid that, in a closed position, obscures a display of a portable electronic device. The method 500 continues and, in response to detecting the lid closure event, performs 504 a color calibration of the display including using a color sensor to measure 506 a color output by the display with the lid in the closed position and updates 508 color calibration parameters for optimizing the color output and the method 500 ends. In various embodiments, the method may be implemented substantially as described above with respect to the function of the apparatuses 200, 300, 400 depicted respectively in FIGS. 2, 3A-3C, and 4A-4B.

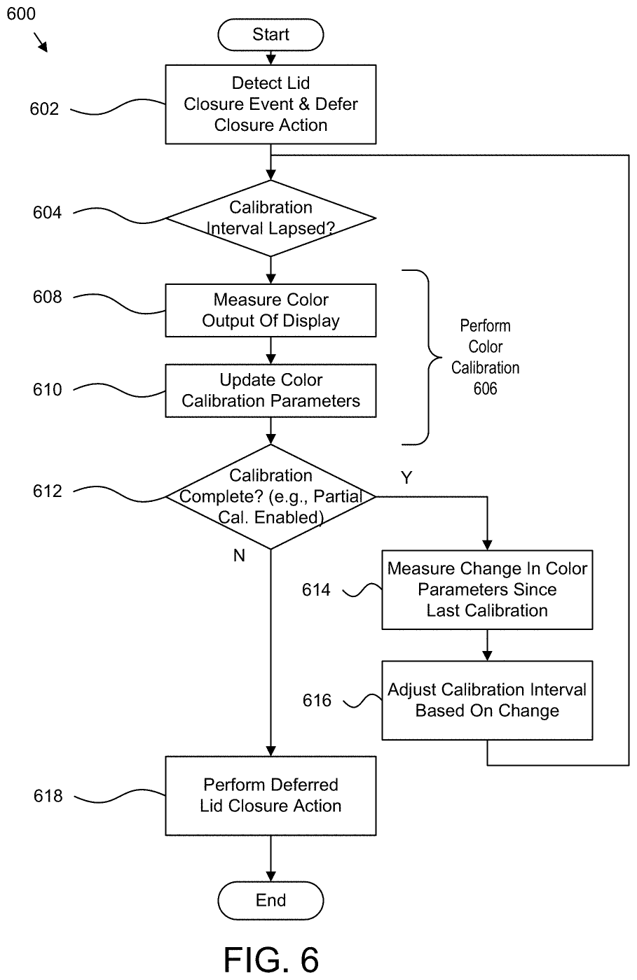

FIG. 6 is a schematic flow chart diagram illustrating another embodiment of a method 600 for automatically calibrating display color output on lid closure. In various embodiments, one or more portions of the method 600 may be skipped or may be performed in a different order than is depicted in FIG. 6. In one embodiment, the method 600 begins and detects 602, by use of a processor, a lid closure event for a lid that, in a closed position, obscures a display of a portable electronic device and defers a lid closure action associated with the type of lid closure event until after color calibration is complete. The method 600 continues and determines 604 whether it is time to calibrate i.e., whether a selected calibration interval has lapsed. The method 600 continues and performs 606 the color calibration by measuring 606 a color output of the display and updating 610 color calibration parameters substantially as described above with respect to FIG. 2.

The method 600 also determines 612 whether partial calibration is enabled and whether all of the partial calibrations have been completed. If yes, the method 600 measures 614 a change in color parameters since the last calibration and adjusts 616 the calibration interval based on the measured change. If no, the method 600 jumps directly to performing 618 the deferred lid closure action and the method 600 ends.

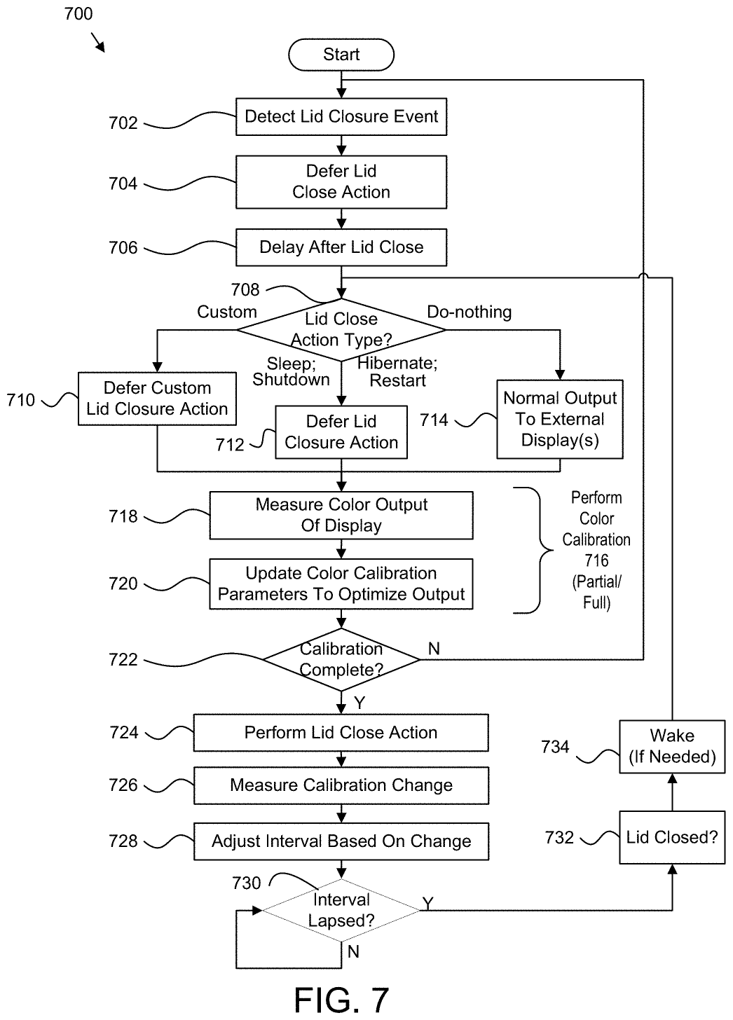

FIG. 7 is a schematic flow chart diagram illustrating another embodiment of a method 700 for automatically calibrating display color output on lid closure. In various embodiments, one or more portions of the method 700 may be skipped or may be performed in a different order than is depicted in FIG. 7. In one embodiment, the method 700 begins and detects702, by use of a processor, a lid closure event for a lid that, in a closed position, obscures a display of a portable electronic device. The method 700 continues and, in some embodiments, defers 704 a specified lid closure action until after color calibration. In certain embodiments, the method 700 delays performing the color calibration until after a predetermined time interval from detecting the lid closure event has lapsed.

In some embodiments, the method 700 determines 706 whether a predetermined time interval from detecting the lid closure event has lapsed. This allows the method 700 to delay a color calibration for a predetermined time after the lid closes.

In various embodiments, the method includes determining 708 a lid closure action type such as for example a sleep action, a shutdown action, a restart action, a hibernate action, a do-nothing action, or a custom action. In various embodiments, in response to the lid closure action type being a custom lid closure action, sleep action a shut down action, a hibernate action, or a restart action, the method 700 may differ 710, 712.

In certain embodiments, in response to the lid closure action, the method 700 performs 716 a color calibration of the display, including using a color sensor to measure 718 a color output by the display with the lid in the closed position and updating 720 color calibration parameters for optimizing the color output.

The method includes, in some embodiments, performing, by use of a processor, a lid closure action selected from a sleep action, a shutdown action, a hibernate action, a restart action, a do-nothing action, and a custom action. In certain embodiments, the method includes performing the lid closure action is in response to completing the color calibration. In various embodiments, in response to the lid closure action being a do-nothing action, the method continues 714 to display content on a second display for the portable electronic device that is not obscured by the lid in the closed position while performing 716 the color calibration on the display that is obscured by the lid in the closed position. In various embodiments, performing 716 the color calibration includes measuring 718 a color output by the display with the lid in a closed position using a color sensor. Performing 716 the color calibration also includes updating 720 color calibration parameters to optimize the color output of the display.

In certain embodiments of the method 700, performing 716 the color calibration includes performing multiple partial full partial color calibrations corresponding to multiple lid closure events. In embodiments in which the method 700 performs 716 multiple partial color calibrations, the method 700 determines 722 whether all of the partial color calibrations are complete.

In various embodiments, the method 700 performs 724 the lid closure action in response to determining 722 that the color calibration is complete. In some embodiments, the method 700 measures 726 a change in the calibration parameters from a preceding color calibration and adjusts 728 the predetermined time interval inversely to the measured change substantially as described above with respect to the scheduling module 220 of the display calibration apparatus 104 depicted in FIG. 3.

In one embodiment, the method 700 determines 730, as a pre-condition to performing the color calibration, whether a predetermined time interval from completion of a prior color calibration has lapsed. In some embodiments, the method 700 performs 716 the color calibration using a Unified Extensible Firmware Interface (UEFI) at the predetermined time interval, where the UEFI application determines 732 whether the lid is closed and in response, wakes 734 the portable electronic device in response to the predetermined time interval lapsing when the portable electronic device is in a state selected from a sleep state, a shutdown state, and a hibernate state and the lid is in the closed position. The method 700 ends in some embodiments and other embodiments returns to the beginning to detect 702 another lid closure event, or in further embodiments to perform the color calibration at the predetermined interval. In some embodiments, the method 700 is performed using one or more of the lid closure detection module 214, the color calibration module 216, the lid closure action module 218 and/or the scheduling module 220 depicted in FIG. 2.

In some embodiments, a program product performs one or more portions of the methods 500, 600 and/or 700. For example, in one embodiment, a program product for automatically calibrating display color output on lid closure includes code that is executable by a processor to detect a lid closure event for a lid that, in a closed position, obscures a display of a portable electronic device, and in response to detecting the lid closure event, to perform a color calibration of the display which includes, in various embodiments, using a color sensor to measure a color output by the display with the lid in the closed position and updating color calibration parameters for optimizing the color output.

Thus, the system 100, apparatuses 200, 300, 400 and methods 500, 600, and 700 may operate according to the various embodiments disclosed herein to improve display color calibration technology by automatically performing color calibration on lid closure. These embodiments provide more convenient ways to perform color calibration. They also provide the benefits associated with regular color calibration such as for example consistent color displayed on different devices, consistent and accurate colors displayed over time, reducing the time the user waits for calibration to complete, and so forth.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor; and
a memory that stores code executable by the processor to perform ongoing partial color calibration of a display of a portable electronic device in response to determining that a partial color calibration mode is enabled, wherein the partial color calibration comprises:
detecting a lid closure event for a lid that closes to obscure the display of the portable electronic device;
in response to detecting the lid closure event, performing a partial color calibration of one selected color channel of a set of color channels output by the display, the partial color calibration comprising:
using a color sensor to measure a color output by the selected color channel of the display with the lid in a closed position
updating color calibration parameters corresponding to the selected color channel to optimize the color output of the selected color channel;
scheduling a next color channel of the set of color channels to be partially color calibrated upon detection of the next lid closure event.

2. The apparatus of claim 1, wherein the code is further executable by the processor to further perform a lid closure action selected from a sleep action, a shutdown action, a hibernate action, a restart action, a do-nothing action, and a custom action.

3. The apparatus of claim 2, wherein the code is further executable by the processor to perform the lid closure action in response to completing the partial color calibration.

4. The apparatus of claim 3, wherein in response to the lid closure action being do-nothing, the code is further executable by the processor to continue to display content on a second display for the portable electronic device that is not obscured by the lid in the closed position while performing the color calibration on the display that is obscured by the lid in the closed position.

5. The apparatus of claim 2, where the set of color channels output by the display comprises a red channel, a green channel, and a blue channel.

6. The apparatus of claim 1, wherein the code is further executable by the processor to determine, as a pre-condition to performing the color calibration, whether a predetermined time interval from completion of a prior color calibration has lapsed.

7. The apparatus of claim 6, wherein the code is further executable by the processor to measure a change in the color calibration parameters from a preceding color calibration and to adjust the predetermined time interval inversely to the measured change.

8. The apparatus of claim 6, wherein the code is further executable by the processor to perform the color calibration using a Unified Extensible Firmware Interface (UEFI) application that performs the color calibration at the predetermined time interval, wherein the UEFI application wakes the portable electronic device in response to the predetermined time interval lapsing when the portable electronic device is in a state selected from a sleep state, a shutdown state, and a hibernate state.

9. The apparatus of claim 1, wherein the code is further executable by the processor to determine, as a pre-condition to performing the color calibration, whether a predetermined time interval from detecting the lid closure event has lapsed.

10. The apparatus of claim 1, wherein the code is further executable by the processor to determine as a further pre-condition to performing the color calibration whether a movement of the portable electronic device is below a predetermined threshold.

11. The apparatus of claim 1, wherein the color sensor is integrated within a surface comprising a user input interface of the portable electronic device that opposes the display with the lid in the closed position.

12. The apparatus of claim 1, wherein the color sensor is integrated within the lid of the portable electronic device that opposes the display with the lid in the closed position.

13. A method comprising:
performing ongoing partial color calibration of a display of a portable electronic device in response to determining that a partial color calibration mode is enabled, wherein the partial color calibration comprises:
detecting, by use of a processor, a lid closure event for a lid that, in a closed position, obscures the display of the portable electronic device;
in response to detecting the lid closure event, performing, by use of a processor, a partial color calibration of one selected color of a set of color channels output by the display, the partial color calibration comprising:
using a color sensor to measure a color output by the selected color channel of the display with the lid in the closed position;
updating color calibration parameters corresponding to the selected color channel to optimize the color output of the selected color channel; and
scheduling a next color channel of the set of color channels to be partially color calibrated upon detection of the next lid closure event.

14. The method of claim 13, further comprising performing, by use of a processor, a lid closure action selected from a sleep action, a shutdown action, a hibernate action, a restart action, a do-nothing action, and a custom action.

15. The method of claim 14, wherein performing the lid closure action is in response to completing the partial color calibration.

16. The method of claim 15, further comprising, in response to the lid closure action being a do-nothing action, continuing to display content on a second display for the portable electronic device that is not obscured by the lid in the closed position while performing the color calibration on the display that is obscured by the lid in the closed position.

17. The method of claim 14, where the set of color channels output by the display comprises a red channel, a green channel, and a blue channel.

18. The method of claim 13, further comprising determining, as a pre-condition to performing the color calibration, whether a predetermined time interval from completion of a prior color calibration has lapsed.

19. The method of claim 18, further comprising performing the color calibration using a Unified Extensible Firmware Interface (UEFI) application at the predetermined time interval, wherein the UEFI application wakes the portable electronic device in response to the predetermined time interval lapsing when the portable electronic device is in a state selected from a sleep state, a shutdown state, and a hibernate state.

20. A program product comprising a non-transitory computer readable storage medium that stores code executable by a processor, the executable code comprising code to perform ongoing partial color calibration of a display of a portable electronic device in response to determining that a partial color calibration mode is enabled, wherein the partial color calibration comprises:
detecting a lid closure event for a lid that closes to obscure the display of the portable electronic device; and
in response to detecting the lid closure event, perform a partial color calibration of one selected color of a set of color channels output by the display comprising:
using a color sensor to measure a color output by the selected color channel of the display with the lid in a closed position;
updating color calibration parameters corresponding to the selected color channel to optimize the color output of the selected color channel; and
scheduling a next color channel of the set of color channels to be partially color calibrated upon detection of the next lid closure event.
